(19) United States
(12) Patent Application Publication
(10) Pub. No.: US 2012/0100510 A1
(43) Pub. Date: Apr. 26, 2012

(54) METHOD FOR COMPUTER EVALUATION OF CONTAINERS AND FOOD TO OBTAIN OPTIMUM STORAGE AND/OR USE

(75) Inventor: Robert R. Turvey, Sanford, MI (US)

(73) Assignee: S.C. JOHNSON & SON INC., Racine, WI (US)

(21) Appl. No.: 13/276,997

(22) Filed: Oct. 19, 2011

Related U.S. Application Data
(60) Provisional application No. 61/344,839, filed on Oct. 21, 2010.

(51) Int. Cl. G09B 19/00

(52) U.S. Cl. 434/127

(57) ABSTRACT

An evaluation method for containers and food to improve storage and use includes determining particular portions of food correlated with size of storage containers for providing portions of specific calorie content; and/or evaluating types of containers and/or settings for containers to accomplish improved storage time. The method includes an electronic device having a database and the capability of modifying and entering information. Typical information is a food product, and type and size of a particular storage container. The method calculates and provides an appropriate setting for the particular container for the particular food, which enhances storage. The method may enable a consumer to identify a portion of a particular food for placement in a pre-set sized container to create a desired calorie content. The consumer can then easily identify the total amount of calories for a particular combination of portions in a meal.

This application claims priority to U.S. Provisional Patent Application No. 61/344,839 filed Oct. 21, 2010, which is incorporated herein by reference.

### FIELD OF INVENTION

The present disclosure is directed to a method of evaluation of containers and food to obtain optimum conditions for storage and/or use. The method of evaluation includes one or a combination of a method of selecting, adjusting or modifying storage containers and/or manner of storage for foods to obtain optimum storage time for specified foods, and/or determining particular portion sizes of foods correlated with sizes of storage containers for providing food portions of particular calorie content.

### BACKGROUND OF THE INVENTION

Food products have a limited freshness time and must be used within a certain time period or the products will spoil and no longer be edible. For example, moisture is advantageous in keeping produce fresh. However, different types of produce require different amounts of moisture to maintain optimum freshness. If produce is left unwrapped in a refrigerator, too much moisture may be lost and the produce will dry out. However, ordinary storage bags and containers may trap too much moisture therein and cause the produce to get mushy. In either case, the freshness time of the produce is decreased due to less than optimum storage conditions.

Optimum storage conditions can increase a product's freshness time while less than optimum storage conditions can lessen the product's period of freshness. Optimum storage conditions will vary depending on the particular product. Further, refrigerators have limited settings for controlling the freshness of products. Further, a selected refrigerator setting may not be optimal for all products contained in the refrigeration storage compartment. Accordingly, various types of containers and bags are used to store different products to help extend the freshness time of these products. When products are not used within a particular time or are stored under less than optimal conditions, the products spoil and must be thrown out resulting in a waste of both product and money.

Further, many products are packaged and sold in containers which contain multiple servings of the product. As a result, the consumer must determine how much of a particular product is in a single serving or how much of the product is equal to a certain amount of calories. This is time consuming with regard to measuring and calculating, particularly when the consumer has limited time to prepare or eat a meal. Also, the consumer may have a predetermined total amount of calories allotted for a particular meal and must determine the amount of food for a certain allotment of calories. Depending on the total calories in the other foods for that meal, the consumer may be able to vary the amount of a certain food to be eaten in a particular meal or day, but would like to make this determination quickly and easily.

### SUMMARY OF INVENTION

In view of the above, there is a need in the market for a method of evaluating containers and foods to determine optimum storage conditions for particular food products in order to maintain freshness and storage time for those products, and/or correlate calorie content of particular foods with storage container sizes with minimal effort by the consumer.

The present disclosure is directed to a method of evaluating containers for food to obtain optimum storage conditions, and/or settings or portions for storage and/or use of particular food products. The method includes at least one electronic device, such as a computer, a smart phone, a personal digital assistant (PDA), or other electronic device capable of storing and manipulating data or making calculations to determine and provide desired new data, and food storage products and devices (e.g., vacuum storage device, sealable containers, flexible pouches with zippers).

The electronic device may have a processor, memory with an instruction set, and other well known components to function as a stand-alone unit and/or may have wireless communication components to access a remote device and the Internet with the desired capabilities. The electronic device includes an application (“app”) to carry out the method by enabling the electronic device to include an internal database with predetermined data, e.g., information re food products and their caloric content and manner of storage thereof, and container types and sizes, which can be added to and manipulated to provide selected correlations in response to various inquiries, such as further described hereafter.

The method includes entering into the database the identity of a food product and a storage container through barcodes thereof. The data entry may be manual entry of the name of the food product and the type of storage container (e.g., by keypad), by voice entry using voice recognition software, by photo entry, or by other suitable means. It is understood that “storage container” can be articles of various styles and sizes, such as substantially rigid containers having a base and lid made of plastic, glass, combination thereof, etc.; or flexible containers such as re-closable storage bags.

The database of the electronic device is provided with pertinent information as to different types of storage containers and information on foods, including calories per different portion sizes, and storage conditions or settings for providing maximum freshness and storage time for the foods when using different types of containers.

In one embodiment of the method, a particular food product and a particular storage container are scanned into or otherwise entered into the application on the electronic device, the device then cross-references the database for that food with the particular storage container, such as by a user inquiry or prompt, to access the appropriate setting on or for the particular container which will provide the optimum freshness for that food product when stored in the type of container entered.

Further, when a particular food product is scanned or otherwise entered into the system of the subject disclosure, the device can prompt the consumer to place a particular portion of that food product in a predetermined size of container based on calorie content or based on storage conditions, e.g. to provide a desired head (air) space for optimal moisture content within the container for the food being stored. The consumer can then quickly and easily identify the total amount of calories for a particular food product in a predetermined size container since the food has already been premeasured into a selected serving size. This enables the consumer to easily calculate and monitor their calorie intake of foods and/or store the food under optimum conditions to extend the freshness life of the food.

It should be appreciated that the present technology can be implemented and utilized in numerous ways, including without limitation as a process, an apparatus, a system, a device, a method for applications now known and later developed or a computer readable medium. The different embodiments of the subject disclosure will be apparent from the following description of the preferred embodiments of the disclosure and from the accompanying drawings.

### BRIEF DESCRIPTION OF THE DRAWINGS

The following detailed description of specific non-limiting embodiments of the present disclosure can be best understood when read in conjunction with the following drawings, where like structures are indicated with like reference numbers.

FIG. 1 illustrates steps for determining storage settings for selected food products in one embodiment of a vented storage bag using the method of the subject disclosure.

FIG. 2 illustrates steps for determining storage settings for selected food products in another embodiment of a vented rigid storage container using the method of the subject disclosure.

FIG. 3 illustrates steps for determining storage settings for selected products as to different containers in another embodiment of a storage container using the method of the subject disclosure.

FIG. 4 illustrates steps for portioning foods into predetermined sizes of containers based on calculated calorie content of a particular food in relation to the food product itself or a meal using the method of the subject disclosure.

### DETAILED DESCRIPTION OF THE PREFERRED EMBODIMENTS

The present disclosure overcomes many of the prior art problems associated with food storage. The advantages, and other features of the methods and systems disclosed herein, will become more readily apparent to those having ordinary skill in the art from the following detailed description of certain preferred embodiments taken in conjunction with the drawings which set forth representative embodiments of the present technology.

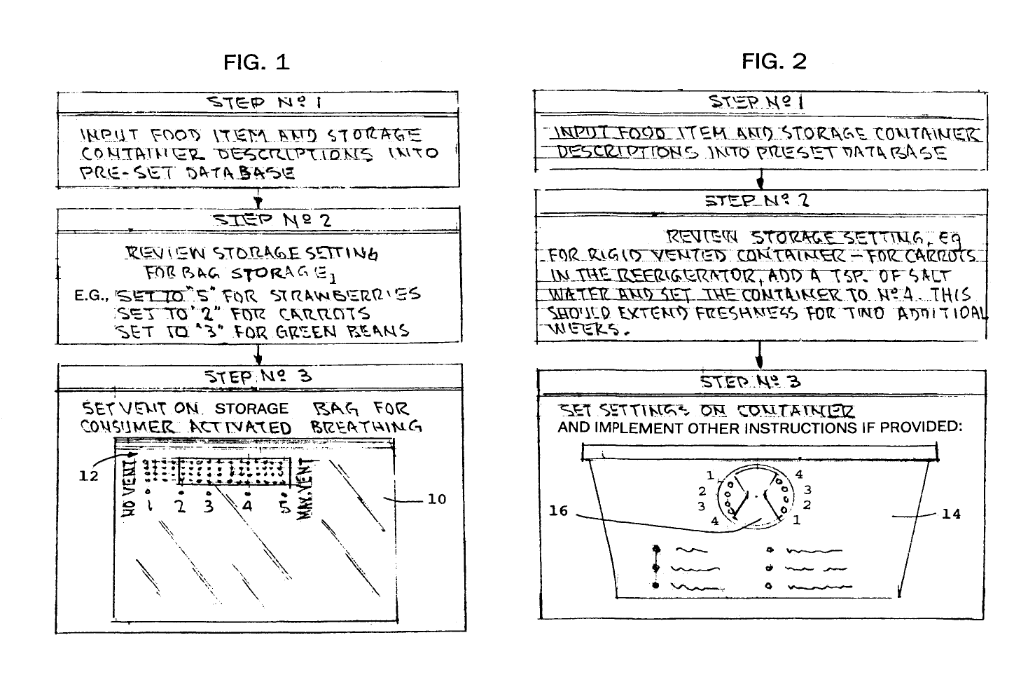

Referring to FIGS. 1-4, the method of the subject disclosure is applied to and used in conjunction with a user's personal computer, smart phone, PDA, food storage device (e.g., vacuum storage device) or other electronic device to enable a consumer as a user to obtain desired storage information for maintaining and extending the freshness of food products or provide portions of the food products according to desired criteria.

According to one embodiment of the method, since moisture can affect the freshness period of many food products, such as produce, e.g., fruits and vegetables, storage containers, either rigid or flexible can include an adjustable vent therein. The adjustable vent enables the consumer to select a particular setting from a range of settings which allows for the optimization of the amount of moisture allowed in a container for a particular product, thereby maximizing the freshness time of the product. The vent can be adjusted to permit excess moisture to escape or moisture to enter as appropriate for the product being stored to stay fresh longer as compared to sealing in a closed off container.

In application of the method on the electronic device, a food product is identified or entered into the database by scanning a barcode for the product, if available, or by other suitable means, such as by manual entry of the name of the food product, voice entry, or photo entry. The type and size of a particular storage container to be used for storing the product is also identified or entered into the database, such as by scanning the barcode on the storage container, manual entry, or other suitable means. The electronic device is provided, either locally or through remote access, with a database of storage containers and settings for various food products when using different types of containers to obtain maximum freshness, i.e., storage time, for various products. Once the particular food product and the particular storage container are scanned into or otherwise entered into the database and linked to the method on the electronic device, the application of the method then cross references, optionally in response to a user's inquiry or prompt, the database of settings for that food with the particular storage container. The appropriate setting for the particular container is then provided to the consumer through an electronic readout in order to achieve an optimum period of freshness of that food product.

FIG. 1 illustrates the steps for determining storage settings for a selected food product in a flexible storage bag 10 which includes an adjustable slide vent 12 for varying the moisture content and air flow in the bag 10. Once a food product and storage bag 10 are scanned or otherwise entered into a database for the electronic device, the consumer reviews the storage setting provided, e.g., set vent to “5” for strawberries; set vent to “2” for carrots; set vent to “3” for green beans; etc. The adjustable slide vent 12 on the storage bag 10 is then set to the suggested setting and the product is stored in the bag 10.

FIG. 2 illustrates steps for determining storage settings for a selected food product in a rigid container 14 having an adjustable dial vent 16. For example, for carrots being stored in container 14 in a refrigerator, the storage setting provided in application of the method is, for example, that a teaspoon of salt water be added thereto and the vent on the container be set to number “4.” According to the application, this particular setting and salt water in the container should optimize the freshness of the carrots, in this example, for a period of an additional two weeks.

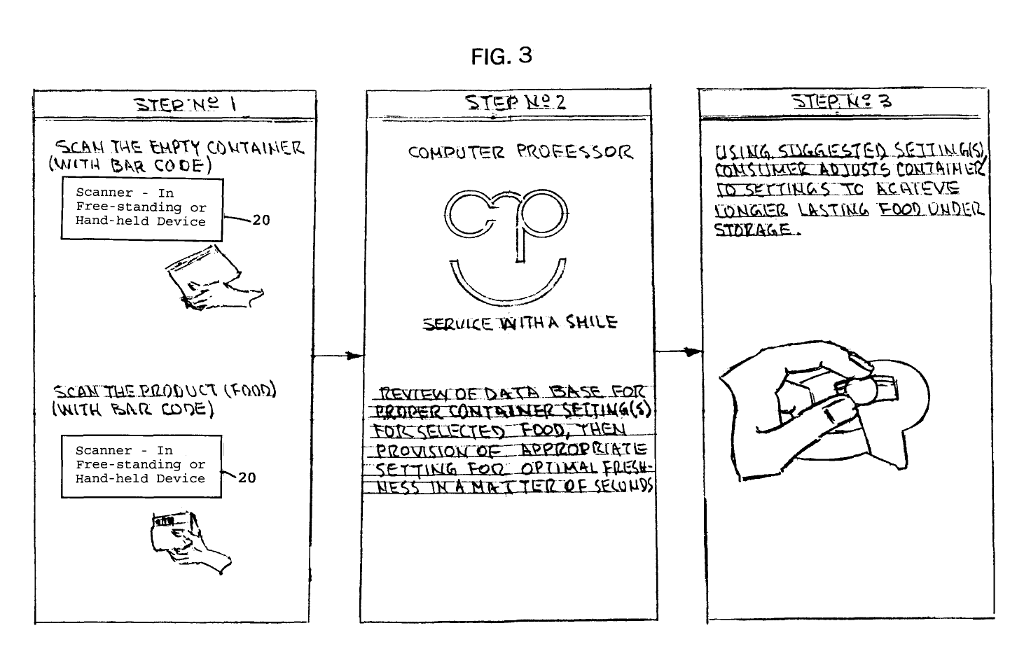

FIG. 3 illustrates steps for selecting storage settings using a scanner for inputting information into a database accessible to the electronic device which carries out the method of the subject disclosure. In particular, a scanner 20 scans a barcode of an empty storage container and a barcode of a food product. The type of storage container (e.g., size, flexible or rigid, type of vent, etc. which can be correlated to a manufacturer's product description pre-entered into the database, or identified through information stored in the barcode for the container) and the identity of the food product are entered into the database using the scanner 20 to scan the barcode of each of the storage container and food product.

The scanner 20 may be a personal scanner which is free-standing or hand-held and is dependent or linked to another device. For example, suitable scanners include commercially available free-standing scanners such as the IKAN Food Scanner, or a scanner present in a smart phone or PDA, or a scanner in a consumer's home which is linked to the consumer's electronic device containing the application, such as a computer, vacuum applicator, and/or the like. In any of these embodiments, the scanner 20 can include voice recognition software so that the consumer can enter the product information by speaking the description of the product. Also, the scanner 20 can include a keypad for manually entering the product information, or include photo entry software. Preferably, a scanner will include the option of manual entry since not all products have barcodes.

Once the product and storage container are identified, the application of the method correlates the data to provide in an electronic readout particular storage parameters, including vent setting, in order for the product to retain optimum freshness in storage such as set forth above in the embodiments illustrated in FIGS. 1 and 2.

An alternative embodiment of the method of the subject disclosure can be used alone or in combination with the embodiments described above. This embodiment involves portioning food into one or more particular sized containers to achieve desired calorie content of the food. The portion provided can be used in isolation as to one particular food or can be portioned in combination with the portioning of other food items so as to obtain a meal have a pre-set total calorie content.

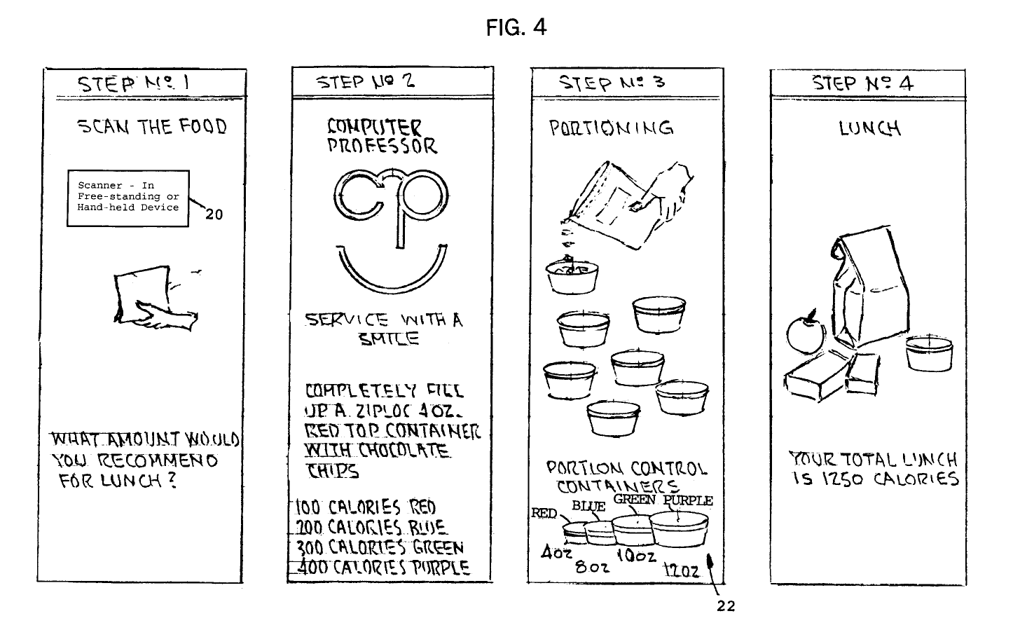

FIG. 4 illustrates an embodiment of this application of the method wherein the food product and container include barcodes. As set forth above, if a barcode is not available, the product and container information can be entered by alternative means, e.g., voice entry, manual (e.g., keypad) entry, photo entry, or the like as available. When the identity of a particular product is entered, the application of the method prompts the consumer to place a particular portion or amount of that food product in a container of a particular size. The method readily calculates and provides the consumer with the calculated total amount of calories for a particular food based on a pre-set size of container. The calories for the food have been determined for a pre-measured portion. This enables the consumer to quickly and easily select or monitor their calorie intake of these foods, in particular if desired in combination with other foods to provide a meal. An example is shown, for example, in FIG. 4.

Particularly, the consumer uses scanner 20 to scan a particular food product. The consumer can request an amount as appropriate for a particular meal, e.g., for lunch. The application of the method then upon processing of the information in view of the request provides the consumer with portion information in relation to filling pre-set sizes of containers with the product to obtain different caloric contents based on amount of product. The various sized containers 22 can be easily distinguished by a selected indicator, such as a different color lid. For example, for chocolate chips, 100 calories of chocolate chips fill a 4-ounce container with a red lid, 200 calories of chocolate chips fill an 8-ounce container with a blue lid, 300 calories of chocolate chips fill a 10-ounce container with a green lid, and 400 calories of chocolate chips fill a 12-ounce container with a purple lid. The consumer can then prepare the desired portion of the product accordingly.

A particular serving size of the product can be easily prepared for a snack or as part of a meal. Further, the total amount of calories for a particular meal can easily be calculated. This provides the user with an efficient manner of controlling and providing portions of food products.

In another embodiment, the bulk food packaging is integrated into the subject technology. For example, a bulk food item includes a barcode on the packaging. Upon scanning in the barcode, the database includes a record of relevant information that may be standard or modified by the user for personal preferences. The information of the accessed record may include recipes, various storage options and techniques and the like.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

What is claimed is:

1. A method of evaluating containers and food products to correlate storage and use there-between, comprising:
at least one electronic device including locally in said device, or being capable of accessing remotely, a database containing pre-set information as to containers and food products;
entering into said database identity of a food product which is to be stored or used;
entering into said database identity of a vented storage container for storing the food product;
cross-referencing the food product and the vented storage container within the database through a user inquiry or prompt;
calculating a vent setting for the vented storage container to provide optimal freshness for the food product during storage; and
providing the vent setting for the vented storage container through electronic readout on the at least one electronic device.

2. The method of claim 1, wherein said entering of said identity of said food product or said vented storage container comprises scanning a barcode thereof, manual entry, voice entry, or photo entry.

3. The method of claim 1, wherein the electronic device comprises at least one of a computer, a smart phone or a personal digital assistant.

4. The method of claim 1, wherein the vented storage container is a rigid container or a flexible container.

5. The method of claim 1, wherein the vent setting provides the vented storage container with a moisture content or air flow which provides increased freshness to the food product upon storage in said vented storage container.

6. A method of determining a portion size of a food product in correlation with calorie content of the food product, comprising:
at least one electronic device including in said device, or being capable of accessing remotely, a database containing pre-set information as to containers and food products;
entering into said database identity of a food product;
calculating an amount of the food product based on calorie content thereof sufficient to fill at least one storage container of a selected size for storing the amount of the food product calculated; and
providing through electronic readout in said at least one electronic device the amount calculated of the food product based on calorie content and identifying the at least one storage container sufficient to hold said amount.

7. The method of claim 6, wherein said entering of the identity of the food product comprises scanning a barcode thereof, manual entry, voice entry, or photo entry.

8. The method of claim 6, wherein the electronic device comprises at least one of a computer, a smart phone or a personal digital assistant.

9. The method of claim 6, wherein the at least one storage container has an indicator for identifying the calorie content of the food product therein.

10. The method of claim 9, wherein the indicator is a color.

11. The method of claim 9, further comprising in said calculating of the amount of the food product consideration of said food product as a component of a meal or a snack having a pre-set total calorie value and determining a maximum amount for the calorie content of the food product which can be present in said meal or snack in combination with other identified components thereof so as not to exceed said total calorie value, and identifying the storage container for storing said maximum amount.

12. The method of claim 6, further comprising selecting a storage container by size and identifying a food product to be stored in said container; calculating the calorie content of said food product based on amount of said food product to fill said storage container; and
providing an electronic readout of said amount based on the calorie content thereof.

13. A process for optimizing storage of food comprising
providing a hand-held electronic device including
(1) at least one data entry component selected from (a) a scanner for reading at least a barcode, (b) a manual data entry component, (c) voice recognition entry component, and (d) photo entry component; and
(2) a database of selected data arranged for searching and retrieval of information therefrom in response to an inquiry or prompt,
inputting into said electronic device via said at least one data entry component identity of at least one food,
inputting into said electronic device via said at least one data entry component identity of at least one container,
download from said database information from said selected data based on said food and said container to provide directions as to manner of modification if any to said container and manner of storage of said food in said container so as to obtain optimum storage of said food.

14. A process according to claim 13, wherein said hand-held electronic device is a smart phone or personal data assistant.

15. A process according to claim 13, wherein said container is a rigid container or a flexible container.

16. A process according to claim 15, wherein said container is a vented container.

17. A process according to claim 13, wherein said selected data includes facts as to said at least one food and said at least one container.
